(19) United States
(12) Patent Application Publication
(10) Pub. No.: US 2026/0221639 A1
(43) Pub. Date: Jul. 30, 2026

(54) PHASE TUNING METHODS FOR TRANSMISSION LINES

(71) Applicant: Telefonaktiebolaget LM Ericsson (publ), Stockholm (SE)

(72) Inventors: Chunyun JIAN, Ottawa (CA); Mi ZHOU, Nepean (CA); Zhen Hong WANG, Stittsville (CA); Yuxing ZHANG, Ottawa (CA)

(21) Appl. No.: 19/146,146

(22) PCT Filed: Jan. 5, 2024
(86) PCT No.: PCT/IB2024/050119

§ 371 Date: Jul. 7, 2025

Related U.S. Application Data
(60) Provisional application No. 63/437,401, filed on Jan. 6, 2023.

(51) Int. Cl. H01P 1/18; H01P 3/00; H01P 3/06; H01P 3/08

(52) U.S. Cl. CPC H01P 1/183; H01P 1/184; H01P 3/003; H01P 3/06; H01P 3/081

(57) ABSTRACT

Methods for phase tuning transmission lines and phase tunable transmission lines are disclosed. According to one aspect, a Single Sub-Array Antenna Filter Unit (SSA-AFU) includes an antenna calibration (AntCal) circuit configured to couple a signal between a sub-array of antenna elements and a calibration port via a tunable transmission line. A tunable transmission line between the AntCal circuit and the calibration port includes at least one tuning screw configured to adjust a capacitance of the tunable transmission line to adjust a phase of signals transported by the tunable transmission line. The calibration port is configured to receive a signal transported by the tunable transmission line.

### TECHNICAL FIELD

This disclosure relates to radio frequency (RF) technology and in particular, to phase tuning methods for transmission lines.

### BACKGROUND

Transmission lines are used extensively in a multitude of applications. Many of these applications depend on accurate knowledge and control of the phase shift introduced by the transmission line as a signal propagates and is transported by the transmission line.

One sub application is a Single Sub-Array Antenna Filter Unit (SSA-AFU) is a basic unit of a modularized antenna array design for Fifth Generation (5G) advanced antenna systems (AAS). The SSA-AFU has an antenna calibration (AntCal) circuit that should have a very accurate phase change between its calibration point and the AntCal port that is connected to the radio transceiver (TRX) board. In general, for mass production of the SSA-AFU, there will be a variation between different SSA-AFU units for the phase change of the AntCal circuit due to manufacturing tolerance of parts. The variation of the phase change must be less than ~4 deg in operating band for the 5G AAS design. FIG. 1 is a schematic of an 8×2 antenna array 2 with sixteen SSA-AFUs 4 for an AAS design.

FIGS. 2 and 3 illustrate one SSA-AFU 4 having two transmit/receive (TX/RX) branches A and B (branches 6). A plurality of antenna elements 8 are mounted on an antenna board 10. A phase shifter 12 may be mounted on an opposite side of the antenna board 10. RF connections 14 between antenna elements 8 and a plurality of filters 16 may be provided. A coupler and combiner printed circuit board (PCB) 18 may be configured with an AntCal circuit 20 that includes couplers A and B (couplers 22) to couple energy from antenna elements 8 to a combiner 24 and to TX/RX filters 16. The combiner 24 is connected to an AntCal port 26. The couplers 22 may be implemented on the coupler and combiner printed circuit board (PCB) 18. The two branches of the couplers 22 combine at the combiner 24. The combiner 24 is electrically coupled to the AntCal port 266 that is connected to a radio TRX board.

A TL (Transmission line) 28 between the AntCal port 26 and the coupler & combiner PCB 18 may be designed using different TL technologies such as a coaxial TL, a microstrip TL, etc., examples of which are disclosed below. The TL 28 may be soldered on the coupler & combiner PCB 18, as well as soldered with a connector of the AntCal port 26.

At 2 Giga-Hertz (GHz), a change in length of the TL 28 of 1 millimeter on a PCB having a relative permittivity of 3.29 (Er=3.29) will cause a phase change of about 3.9 degrees, and a change in length of an air coaxial TL 28 of 1 millimeter will cause a phase change of about 2.4 degrees. The soldering connections on the coupler & combiner PCB 18 and with a connector of the AntCal port 26 may introduce a phase change uncertainty that may be in the range of 2 to 5 degrees. Therefore, the variation of the phase change from filter RF ports A and B to the AntCal port 26 between different SSA-AFUs 4 is difficult to be controlled to be less than about 4 degrees, due to limitations of mechanical manufacture technologies. There has not yet been an available phase-tuning method for the TL that may be applied on the AntCal circuit design of the SSA-AFU.

### SUMMARY

Tunable transmission lines and methods for tuning a transmission line in a SSA-AFU are disclosed. In some embodiments, parallel capacitors with a small value of capacitance are connected in a middle of a transmission line to introduce a small phase change of the transmission line with very little degradation of return loss. In some embodiments, additional tuning capacitors may be connected in a middle of the transmission line to achieve a greater phase change.

Some embodiments, provide control over the phase change introduced by a transmission line. In some embodiments, at least one tuning screw is configured to along a length of a transmission line and may be turned through a first conductor of the transmission line, or a metal bracket electrically connected to the transmission line, toward a second conductor of the transmission line. By turning the tuning screw, the capacitively coupling of the transmission line can be changed, thereby adjusting the phase change that a signal undergoes as it propagates on the transmission line.

Embodiments of the present disclosure provide one or more tuning screws configured to adjust the phase change from radio frequency (RF) filter ports A and B to the AntCal port of an SSA-AFU unit. In some embodiments, the AntCal TL is a coaxial structure, i.e., coaxial transmission line, and each tuning screw is mounted such that it is electrically connected to the outer conductor of the coaxial structure and extends toward the inner conductor. A gap between the inner conductor and the tuning screw may be adjusted by turning the tuning screw, to adjust a capacitive coupling and thereby cause a phase change of signals propagating through the TL.

In some embodiments, the AntCal TL is a stripline structure, and each tuning screw is mounted in a conductive bridge structure such that it is electrically connected to the ground plane (e.g., using vias extending through the PCB dielectric layer) and extends toward the stripline. A gap between the stripline and each tuning screw may be adjusted by turning the tuning screw to adjust a capacitive coupling and thereby cause a phase change of signals propagating through the TL.

In some embodiments, the AntCal TL is a coplanar waveguide structure, and each tuning screw is mounted in a conductive bridge structure such that it is electrically connected to the ground plane and extends toward the conductor. A gap between the conductor and each tuning screw may be adjusted by turning the tuning screw to adjust a capacitive coupling and thereby cause a phase change of signals propagating through the TL.

In some embodiments, an end face of the tuning screw is covered by a dielectric material to prevent an electrical short in the event that the end of the tuning screw contacts the conductor or stripline.

Some embodiments may provide one or more of the following technical advantage(s): phase differences in the AntCal circuits of multiple SSA-AFUs may be minimized in a modularized antenna array.

According to one aspect, a phase-tunable transmission line having at least a first conductor and a second conductor is provided. The phase-tunable transmission line includes at least one tuning screw configured to be turned through the first conductor, or a metal bracket electrically connected to the first conductor, toward the second conductor, the at least one tuning screw being configured, when turned, to adjust a phase change in a signal that propagates along the tunable transmission line.

According to this aspect, in some embodiments, the phase-tunable transmission line is a coaxial transmission line. In some embodiments, the first conductor is an outer conductor of the coaxial transmission line and the second conductor is a center conductor of the coaxial transmission line. In some embodiments, the phase-tunable transmission line is a microstrip transmission line. In some embodiments, the second conductor is a microstrip of the microstrip transmission line and the at least one tuning screw is configured to turn inward through a metal bracket toward the microstrip of the microstrip transmission line. In some embodiments, the metal bracket is connected to a ground plane of the microstrip transmission line through vias. In some embodiments, the tunable transmission line is a coplanar waveguide transmission line. In some embodiments, the second conductor is a center conductor of the coplanar waveguide transmission line and the at least one tuning screw is configured to turn inward through a metal bracket toward a center conductor of the coplanar waveguide transmission line. In some embodiments, the metal bracket is connected to planar conducting strips on either side of the center conductor of the coplanar waveguide transmission line. In some embodiments, the at least one tuning screw includes a dielectric layer at an inserted end of the tuning screw.

According to another aspect, a method of tuning a phase-tunable transmission line having at least a first conductor and a second conductor is provided. The method includes turning at least one tuning screw through the first conductor, or a metal bracket electrically connected to the first conductor, toward the second conductor, the at least one tuning screw being configured, when turned, to adjust a phase change in a signal that propagates along the tunable transmission line.

According to this aspect, in some embodiments, the method includes turning the tuning screw to adjust a capacitance of the tunable transmission line. In some embodiments, turning the at least one tuning screw includes positioning inserted ends of a plurality of tuning screws to be a same distance from the second conductor of the phase-tunable transmission line. In some embodiments, the method includes turning the at least one tuning screw to obtain a specified tradeoff between phase change and insertion loss. In some embodiments, the phase-tunable transmission line is one of a coaxial transmission line, a microstrip transmission and a coplanar waveguide transmission line.

According to yet another aspect, a single sub-array antenna filter unit (SSA-AFU) includes an antenna calibration, AntCal, circuit configured to couple a signal between a sub-array of antenna elements and a calibration port via a tunable transmission line. The SSA-AFU includes a tunable transmission line between the AntCal circuit and the calibration port, the tunable transmission line including at least one tuning screw configured to adjust a capacitance of the tunable transmission line to adjust a phase of signals transported by the tunable transmission line. The SSA-AFU also includes a calibration port configured to receive a signal transported by the tunable transmission line.

According to this aspect, in some embodiments, the tunable transmission line is a coaxial transmission line, e.g., coaxial cable. In some embodiments, the at least one tuning screw is configured to screw inward through an outer conductor of the coaxial transmission line toward an center conductor of the coaxial transmission line. In some embodiments, the tunable transmission line is a microstrip transmission line. In some embodiments, the at least one tuning screw is configured to screw inward through a metal bracket toward a microstrip of the microstrip transmission line. In some embodiments, the metal bracket is connected to a ground plane of the microstrip transmission line through vias. In some embodiments, the tunable transmission line is a coplanar waveguide transmission line. In some embodiments, the at least one tuning screw is configured to screw inward through a metal bracket toward a center conductor of the coplanar waveguide transmission line. In some embodiments, the metal bracket is connected to planar conducting strips on either side of the center conductor of the coplanar waveguide transmission line. In some embodiments, the at least one tuning screw includes a dielectric layer at an inserted end of the tuning screw.

According to another aspect, a method of manufacture of a Single Sub-Array Antenna Filter Unit, SSA-AFU, is provided, the SSA-AFU comprising a tunable transmission line between an antenna calibration circuit and a calibration port. The method includes configuring at least one tuning screw to be turned through a first conductor or a metal bracket toward a second conductor the second conductor being a conductor of the tunable transmission line, the at least one tuning screw being configured to adjust a phase change in a signal that propagates along the tunable transmission line.

According to this aspect, in some embodiments, configuring the at least one tuning screw includes configuring the at least one tuning screw to adjust a capacitance of the tunable transmission line. In some embodiments, configuring the at least one tuning screw includes positioning inserted ends of a plurality of tuning screws to be a same distance from the second conductor of the tunable transmission line. In some embodiments, configuring the at least one tuning screw includes configuring the at least one tuning screw to obtain a specified tradeoff between phase change and insertion loss. In some embodiments, configuring the at least one tuning screw includes configuring the tuning screw to enable adjusting the phase change within an 8 degree range. In some embodiments, configuring the at least one tuning screw includes configuring the at least one tuning screw to enable adjusting the phase change within a 14 degree range. In some embodiments, configuring the at least one tuning screw includes configuring the at least one tuning screw to enable selecting a return loss that does not exceed 14 dB. In some embodiments, configuring the at least one tuning screw includes configuring the at least one tuning screw to enable selecting a return loss that does not exceed 18 dB.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an illustration of an 8×2 SSA-AFU antenna array;

FIG. 2 depicts an SSA-AFU;

FIG. 3 is an SSA-AFU circuit diagram;

FIG. 4 is a circuit diagram with one tuning capacitor;

FIG. 5 is a circuit diagram with two tuning capacitors;

FIG. 6 is a graph of S21 phase versus tuning capacitance for one and two tuning capacitors;

FIG. 7 is a graph of return loss versus tuning capacitance for one and two tuning capacitors;

FIG. 8 is a coaxial transmission line with one tuning screw constructed according to principles disclosed herein;

FIG. 9 is a coaxial transmission line having circular cross section with two tuning screws constructed according to principles disclosed herein;

FIG. 10 is a rectangular coaxial transmission line having rectangular cross section with two tuning screws constructed according to principles disclosed herein;

FIG. 11 is a microstrip transmission line with two tuning screws constructed according to principles disclosed herein;

FIG. 12 is a coplanar waveguide transmission line with two tuning screws constructed according to principles disclosed herein;

FIG. 13 is an SSA-AFU with phase tuning according to principles disclosed herein;

FIG. 14 is an example of a communication system in accordance with some embodiments having radios with advanced antenna systems that include tunable transmission lines configured according to principles disclosed herein;

FIG. 15 is a user equipment (UE) in accordance with some embodiments having radios with advanced antenna systems that include tunable transmission lines configured according to principles disclosed herein;

FIG. 16 is a network node in accordance with some embodiments having radios with advanced antenna systems that include tunable transmission lines configured according to principles disclosed herein;

FIG. 17 is a block diagram of an example embodiment of the host of FIG. 14;

FIG. 18 is a block diagram illustrating a virtualization environment in which functions implemented by some embodiments may be virtualized;

FIG. 19 is a communication diagram of a host communicating via a network node with a UE over a partially wireless connection in accordance with some embodiments; and

FIG. 20 is a flowchart of an example process for tuning a phase-tunable transmission line;

FIG. 21 is a flowchart of an example process for manufacturing a tunable transmission line.

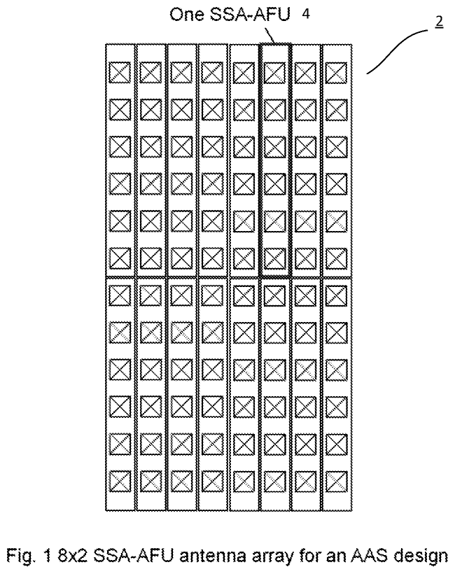

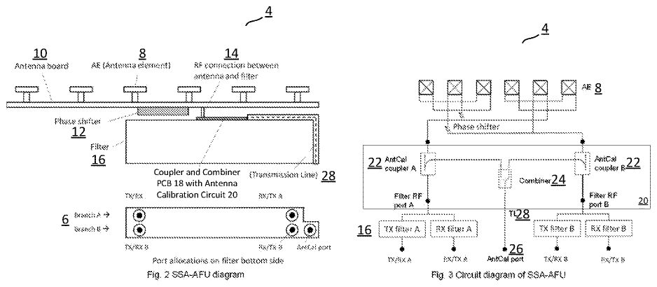

### DETAILED DESCRIPTION

Before describing in detail exemplary embodiments, it is noted that the embodiments reside primarily in combinations of apparatus components and processing steps related to phase tuning methods for transmission lines. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

Some of the embodiments contemplated herein will now be described more fully with reference to the accompanying drawings. Embodiments are provided by way of example to convey the scope of the subject matter to those skilled in the art.

In some embodiments, a phase-tunable transmission line is provided. The transmission line can be designed and manufactured in various technologies to have a very good return loss, say, better than 30 dB. However, from a practical point of view, a TL with better than 15 dB return loss is more than enough for many RF applications. In some embodiments, a tradeoff between the return loss margin (from 30 dB to 15 dB) and phase change may be obtained. In some embodiments, small parallel tuning capacitors are very easy to be implemented on an RF modular design. A tuning range of the phase change obtainable by using the parallel tuning capacitors configured as disclosed herein is wide enough for many RF applications including SSA-AFU applications. Embodiments disclosed herein provide a low cost and effective solution for SSA-AFU applications that enables use of the SSA-AFU in 5G radios.

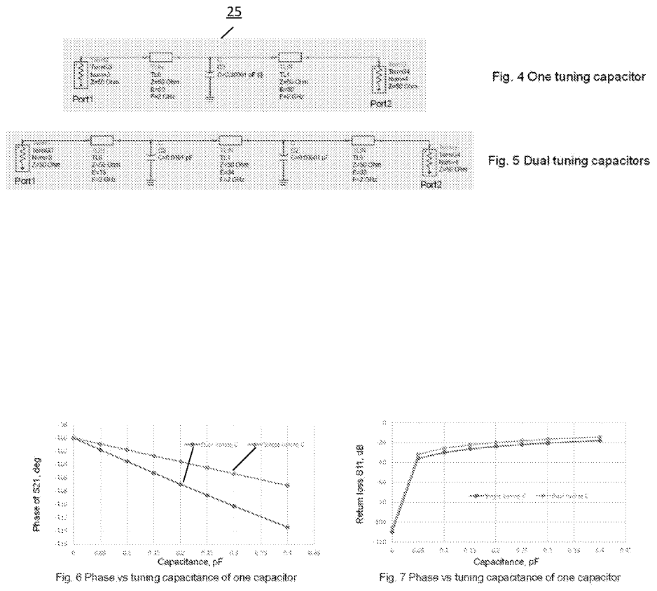

Returning now to the drawing figures, FIG. 4 is a circuit diagram of a transmission line 25 with one tuning capacitor C3 corresponding to a capacitance that is adjustable by turning a tuning screw 30 configured according to principles disclosed herein to vary a capacitive coupling and thereby cause a phase change of signals propagating through the TL 24 between port 1 and port 2. FIG. 5 is a circuit diagram with two tuning capacitors C2 and C3. Each tuning capacitor in FIG. 5 corresponds to a capacitance that is adjustable by turning a tuning screw 30 configured according to principles disclosed herein to vary a capacitive coupling and thereby cause a phase change of signals propagating through the TL 24 between port 1 and port 2.

FIG. 6 illustrates an amount of phase of S21 between ports 1 and 2 versus capacitance in pico-Farads (pF) for a single tuning screw and also shows an amount of phase between ports 1 and 2 versus capacitance for a two tuning screws 30. For the single tuning screw configuration, by tuning the capacitance from 0 pF to 0.4 pF, the phase change from port 1 to port 2 can be tuned from −100 degrees to −107.16 degrees. In the two tuning screws configuration, by tuning the capacitance from 0 pF to 0.4 pF, the phase change from port 1 to port 2 can be tuned from −100 degrees to −113.44 degrees.

FIG. 7 illustrates return loss (S11) at one of ports 1 or 2, for the single tuning screw configuration and the two tuning screws configuration. At a capacitance of 0.4 pF, the return loss for the single tuning screw configuration and for the two tuning screws configuration are 14.55 dB and 18.08 dB, respectively. These results show that these embodiments are adequate to overcome any phase uncertainty arising from manufacturing variations, while achieving good return loss characteristics.

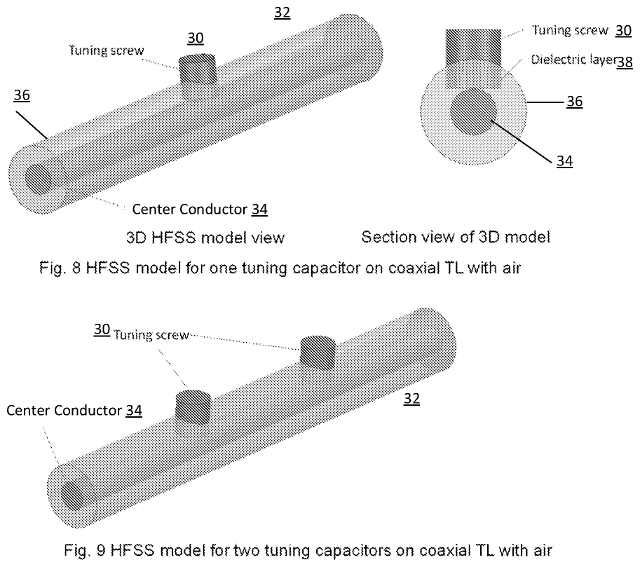

FIGS. 8-12 show phase-tunable transmission lines that may be used in applications where adjustment of a phase change introduced to a signal propagating on the transmission line is desired.

FIG. 8 illustrates an example embodiment of a tunable transmission line 32 that includes a coaxial transmission line with air and with one tuning screw 30 at right angles to a direction of the tunable transmission line 32. The space between the center conductor 34 and the outer conductor 36 of the tunable transmission line 32 may be air, for example. A dielectric layer 38 may be applied to the inserted end of the tuning screw 30 to prevent the tuning screw 30 from making electrical contact with the center conductor 34 of the coaxial tunable transmission line 32.

FIG. 9 illustrates a coaxial tunable transmission line 32 with air and with two tuning screws 30 at right angles to a direction of the coaxial tunable transmission line 32. Each tuning screw 30 may be turned into the space between the center conductor 34 and the outer conductor 36 by a same distance. The space between the center conductor 34 and the outer conductor 36 of the tunable transmission line 32 may be air, for example. A dielectric layer 38 may be applied to the inserted end of each tuning screw 30 to prevent the tuning screw 30 from making electrical contact with the center conductor 34 of the coaxial tunable transmission line 32.

Table 1 shows phase change, return loss and insertion loss for the coaxial structures of FIGS. 8 and 9 when the space between the center conductor 34 and the outer conductor 36 of the coaxial tunable transmission line 32 is air and where the dielectric layer 38 is applied to the inserted ends of the tuning screws 30. The values in Table 1 are obtained from high frequency simulation for a center conductor diameter of 2 mm, an outer conductor diameter of 4.605 mm, and for a dielectric layer having a relative permittivity of 3.29 and a thickness of 0.05 mm.

TABLE 1

| | Phase | Return | Insertion |
|---|---|---|---|
| | Change | Loss | Loss |
| | (degrees) | (dB) | (dB) |
| With No Tuning Screw | −90 | >30 | ~0 |
| With One Tuning Screw (FIG. 8) | −96.25 | 17.64 | 0.076 |
| With Two Tuning Screws (FIG. 9) | −101.52 | 13.58 | 0.1959 |

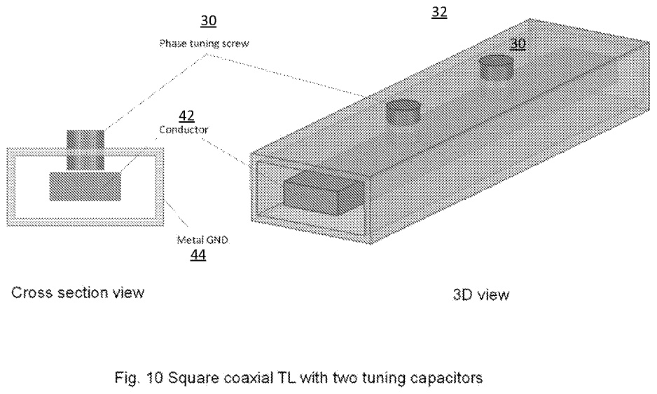

FIG. 10 illustrates a rectangular coaxial tunable transmission line 32 with two tuning screws 30. Each tuning screw 30 may be turned into the space between the inner rectangular conductor 42 and the outer rectangular conductor 44 to adjust a coupling capacitance to vary the amount of phase change of a signal transported by the rectangular coaxial tunable transmission line 32. A dielectric layer 38 may be applied to the inserted end of each tuning screw 30 to prevent the tuning screw 30 from making electrical contact with the inner rectangular conductor 42 of the rectangular coaxial tunable transmission line 32.

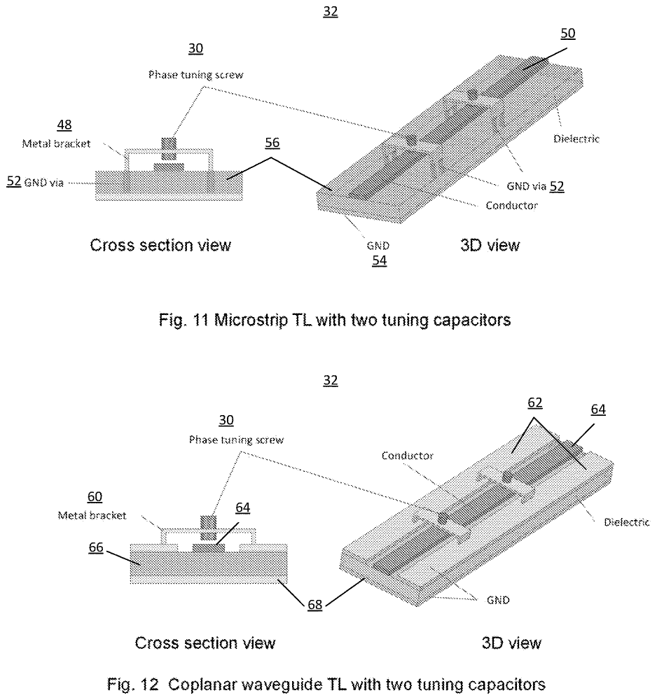

FIG. 11 illustrates a microstrip tunable transmission line 32 with two tuning screws 30. In the example of FIG. 11, each tuning screw 30 may be turned through a metal bracket 48 toward the microstrip 50. The metal bracket 48 for each tuning screw may be connected by vias 52 to a ground plane 54 on one side of a printed circuit board structure 56 carrying the microstrip 50. A dielectric layer 38 may be applied to the inserted end of the tuning screw 30 to prevent the tuning screw 30 from making electrical contact with the microstrip 50 of the tunable transmission line 32.

FIG. 12 illustrates a coplanar waveguide tunable transmission line 32 with two tuning screws 30 that are turned through a metal bracket 60 that is grounded to each ground strip 62 on either side of the center conductor 64 of the coplanar waveguide tunable transmission line 32. The ground strips 62 and the center conductor 64 are shown mounted on a PCB 66 with a ground plane 68 on an opposite side of the PCB 66.

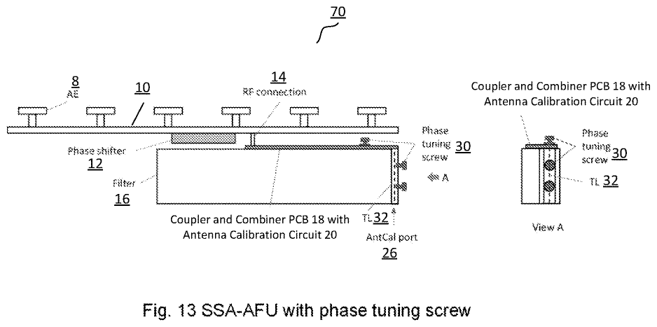

One example application of the phase-tunable transmission lines disclosed herein are SSA-AFUs. FIG. 13 shows an SSA-AFU 70 with antenna elements 8, antenna board 10, a phase shifter 12, an RF connection 14, a filter 16, a coupler and combiner PCB 18 with an AntCal circuit 20, tuning screws 30, tunable transmission line 32 and AntCal port 26. Note that for each of the different types of transmission lines disclosed herein, there may be one, two or more tuning screws 30 where each tuning screw 30 may have a dielectric layer 38 on its inserted end. Thus, according to one aspect, a Single Sub-Array Antenna Filter Unit, SSA-AFU 70, is configured with an antenna calibration, AntCal, circuit 20 on a coupler and combiner PCB 18. The AntCal circuit 20 is configured to couple a signal between a sub-array of antenna elements 8 and a calibration port 26 via a tunable transmission line 32. The SSA-AFU 70 also includes a tunable transmission line 32 between the AntCal circuit 20 and the calibration port, the tunable transmission line 32 including at least one tuning screw 30 configured to adjust a capacitance of the tunable transmission line 32 to adjust a phase of signals transported by the tunable transmission line 32. The SSA-AFU 70 also includes a calibration port 26 configured to receive a signal transported by the tunable transmission line 32. Examples of the tunable transmission line 32 depicted in FIG. 13 are shown in FIGS. 8-12.

In each of the above-disclosed embodiments, there is a first conductor through which the tuning screw 30 is turned and there is a second conductor toward which the tuning screw 30 is turned. In FIGS. 8 and 9, the first conductor is the outer conductor 36 and the second conductor is the center conductor 34. In FIG. 10, the first conductor is the outer rectangular conductor 44 and the second conductor is the inner rectangular conductor 42. In FIG. 11, the first conductor is the metal bracket 48 and the second conductor is the microstrip 50. In FIG. 12, the first conductor is the metal bracket 60 and the second conductor is the center conductor 64.

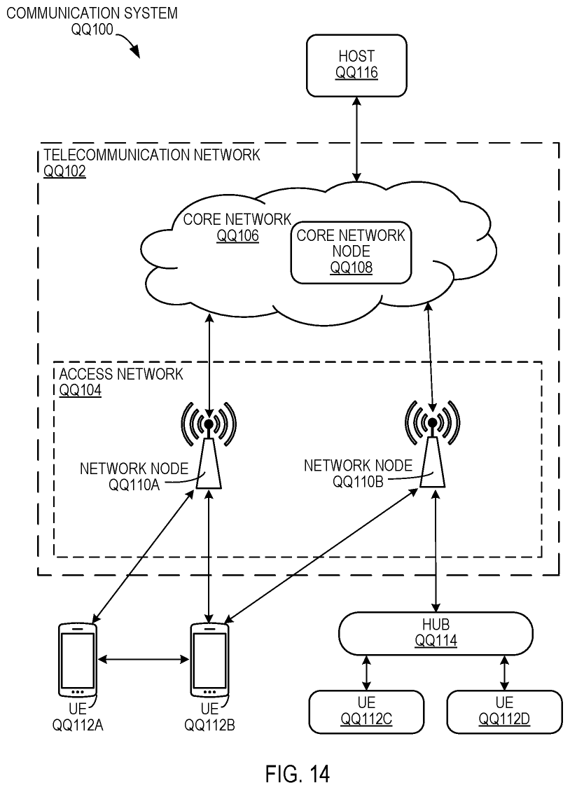

SSU-AFU 70 with phase tunable transmission lines 32 may be employed in a variety of applications, including wireless communications. FIG. 14 is an example of a communication system QQ100 in accordance with some embodiments where SSU-AFU 70 with phase tunable transmission lines 32 can be implemented. In the example of FIG. 14, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (Wi-Fi); and/or any other appropriate wireless communication standard, such as the Worldwide Interoperability for Microwave Access (WiMAX), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

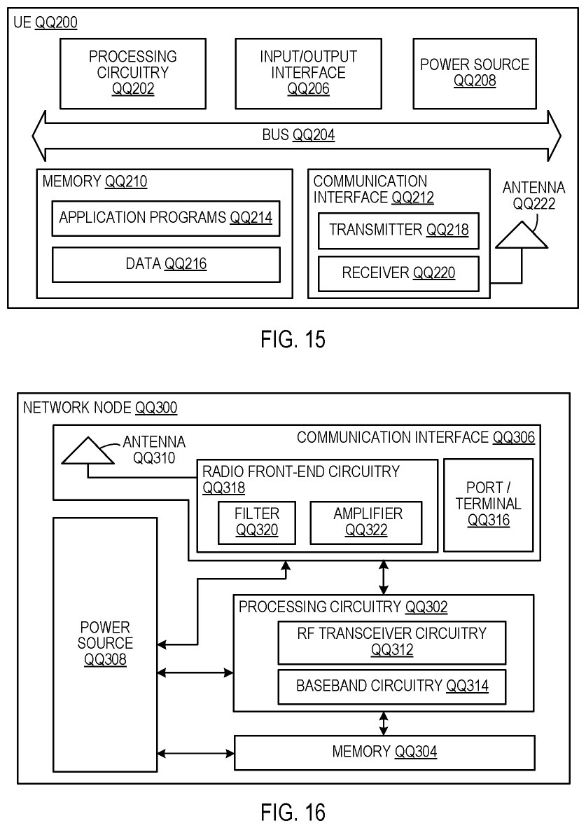

FIG. 15 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMAX, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE may be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 15.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE may also include more than one of the functionalities described above. For example, a UE might comprise the sensor and the actuator, and handle communication of data for both the speed sensor and the actuators.

FIG. 16 is a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, Wi-Fi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 16 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

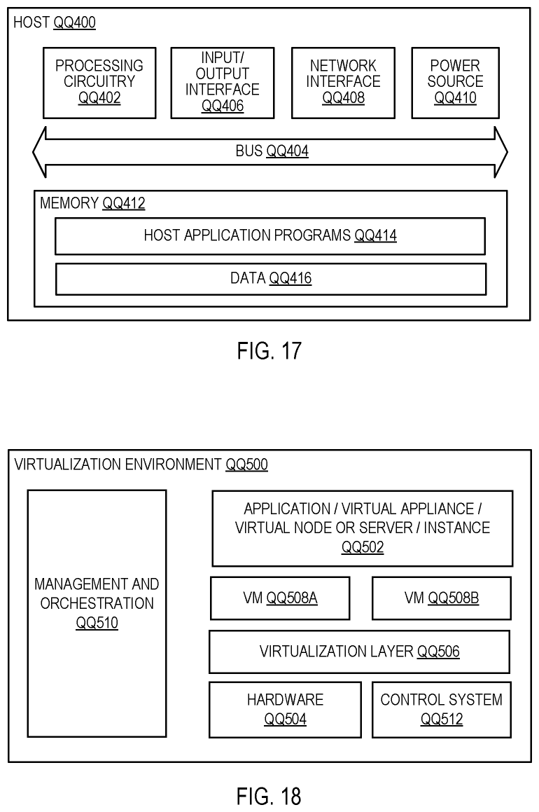

FIG. 17 is a block diagram of a host QQ400, which may be an embodiment of the host QQ116 of FIG. 14, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 18 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization may be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which may be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling may be provided with the use of a control system QQ512 which may alternatively be used for communication between hardware nodes and radio units.

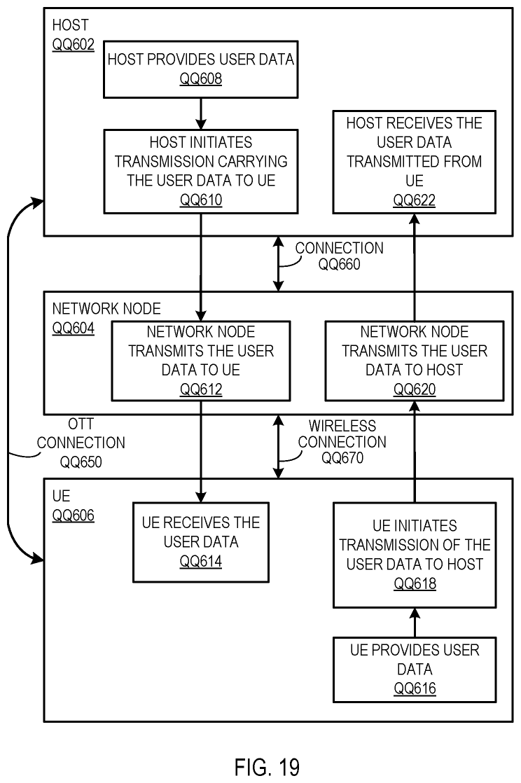

FIG. 19 is a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 14 and/or UE QQ200 of FIG. 15), network node (such as network node QQ110a of FIG. 14 and/or network node QQ300 of FIG. 16), and host (such as host QQ116 of FIG. 14 and/or host QQ400 of FIG. 18) discussed in the preceding paragraphs will now be described with reference to FIG. 19.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 14) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the data rate and/or power consumption and thereby provide benefits such as reduced user waiting time, relaxed restriction on file size, improved content resolution, better responsiveness, and extended battery lifetime.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it may broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

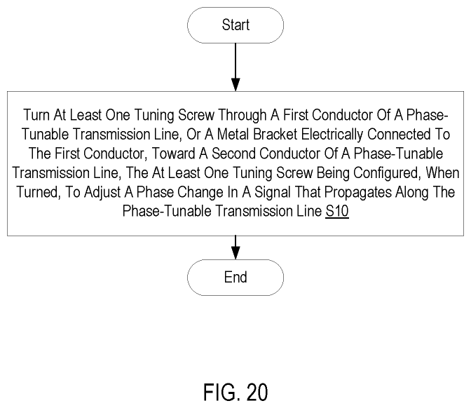

FIG. 20 is a flowchart of an example process of tuning a phase-tunable transmission line having at least a first conductor 36, 44 and a second conductor 34, 42, 50, 64. The method includes turning at least one tuning screw 30 through the first conductor 36, 44, or a metal bracket electrically connected to the first conductor 36, 44, toward the second conductor 34, 42, 50, 64, the at least one tuning screw 30 being configured, when turned, to adjust a phase change in a signal that propagates along the phase-tunable transmission line 32 (Block S10).

According to this aspect, in some embodiments, the method includes turning the tuning screw 30 to adjust a capacitance of the phase-tunable transmission line 32. In some embodiments, turning the at least one tuning screw 30 includes positioning inserted ends of a plurality of tuning screws 30 to be a same distance from the second conductor 34, 42, 50, 64 of the phase-tunable transmission line 32. In some embodiments, the method includes turning the at least one tuning screw 30 to obtain a specified tradeoff between phase change and insertion loss. In some embodiments, the phase-tunable transmission line 32 is one of a coaxial transmission line, a microstrip transmission and a coplanar waveguide transmission line.

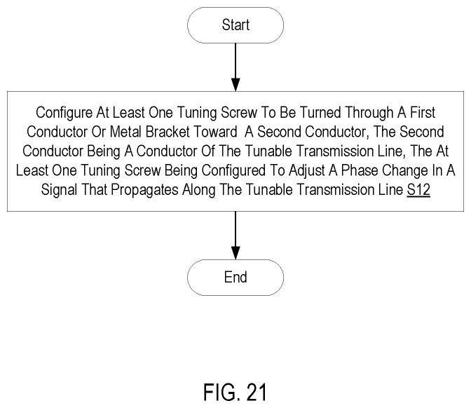

FIG. 21 is a flowchart of an example process of manufacturing a tunable transmission line. The process includes configuring at least one tuning screw 30 to be turned through a first conductor 36, 44 or metal bracket 48, 60 toward a second conductor 34, 42, 50, 64, the second conductor 34, 42, 50, 64 being a conductor of the tunable transmission line 32, the at least one tuning screw 30 being configured to adjust a phase change in a signal that propagates along the tunable transmission line 32 (Block S12).

In some embodiments, configuring the at least one tuning screw 30 includes configuring the at least one tuning screw to adjust a capacitance of the tunable transmission line 32. In some embodiments, configuring the at least one tuning screw 30 includes positioning inserted ends of a plurality of tuning screws 30 to be a same distance from the second conductor 34, 42, 50, 64 of the tunable transmission line 32. In some embodiments, configuring the at least one tuning screw 30 includes configuring the at least one tuning screw 30 to obtain a specified tradeoff between phase change and insertion loss. In some embodiments, configuring the at least one tuning screw 30 includes configuring the tuning screw 30 to enable adjusting the phase change within an 8 degree range. In some embodiments, configuring the at least one tuning screw 30 includes configuring the at least one tuning screw 30 to enable adjusting the phase change within a 14 degree range. In some embodiments, configuring the at least one tuning screw 30 includes configuring the at least one tuning screw 30 to enable selecting a return loss that does not exceed 14 dB. In some embodiments, configuring the at least one tuning screw 30 includes configuring the at least one tuning screw 30 to enable selecting a return loss that does not exceed 18 dB.

Some embodiments may include one or more of the following:

### GROUP A EMBODIMENTS

1. A Single Sub-Array Antenna Filter Unit (SSA-AFU) comprising:
an antenna sub-array including at least one antenna calibration (AntCal) circuit;
a calibration port; and
a transmission line (TL) connecting the at least one AntCal circuit to the calibration port, the TL including at least one phase adjustment screw configured to adjust a phase length of the TL.

2. The SSA-AFU of Embodiment 1, wherein the TL is a coaxial structure having an outer shield and an inner conductor, and wherein the at least one phase adjustment screw is mounted in the outer shield and projects toward the inner conductor.

3. The SSA-AFU of Embodiment 1, wherein the TL is a stripline structure having a ground plane and a conductor disposed on opposite sides of a dielectric layer, and wherein the at least one phase adjustment screw is mounted in an electrically conductive bridge and projects toward the inner conductor, the electrically conductive bridge being connected to the ground plane and extending over the stripline.

4. The SSA-AFU of Embodiment 1, wherein the TL is a coplanar waveguide structure having a ground plane and a conductor disposed on opposite sides of a dielectric layer, and wherein the at least one phase adjustment screw is mounted in an electrically conductive bridge and projects toward the conductor, the electrically conductive bridge being electrically connected to the ground plane and extending over the conductor.

5. The SSA-AFU of any of the previous embodiments, further comprising a dialectic layer disposed on a face of the at least one phase adjustment screw so as to prevent an electrical short due to the face of the at least one phase adjustment screw contacting the inner conductor/stripline/conductor.

### GROUP B EMBODIMENTS

6. A method of calibrating an Antenna Array System (AAS) comprising a plurality of Single Sub-Array Antenna Filter Units (SSA-AFUs), each SSA-AFU including: an antenna sub-array having at least one antenna calibration (AntCal) circuit; a calibration port; and a transmission line (TL) connecting the at least one AntCal circuit to the calibration port, the TL including at least one phase adjustment screw configured to adjust a phase length of the TL, the method comprising adjusting the at least one phase adjustment screw of each SSA-AFU to minimize a phase difference between the calibration port of a first one of the SSA-AFUs and the calibration port of a second one of the SSA-AFUs.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry may be configured to perform the described functionality. The benefits provided by such functionality are not limited to the processing circuitry alone or to other components of the computing device, but are enjoyed by the computing device as a whole, and/or by end users and a wireless network generally.

Abbreviations that may be used in the preceding description include:

| Abbreviation | Explanation |
|---|---|
| AE | Antenna Element |
| AntCal | Antenna Calibration |
| PCB | Printed Circuit Board |
| SSA-AFU | Single Sub-Array Antenna Filter Unit |
| TL | Transmission Line |
| TRX | Transceiver |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A phase-tunable transmission line having at least a first conductor and a second conductor, the phase-tunable transmission line comprising:
at least one tuning screw configured to be turned through the first conductor, or a metal bracket electrically connected to the first conductor, toward the second conductor, the at least one tuning screw being configured, when turned, to adjust a phase change in a signal that propagates along the tunable transmission line.

2. The phase-tunable transmission line of claim 1, wherein the phase-tunable transmission line is a coaxial transmission line.

3. The phase-tunable transmission line of claim 2, wherein the first conductor is an outer conductor of the coaxial transmission line and the second conductor is a center conductor of the coaxial transmission line.

4. The phase-tunable transmission line of claim 1, wherein the phase-tunable transmission line is a microstrip transmission line.

5. The phase-tunable transmission line of claim 4, wherein the second conductor is a microstrip of the microstrip transmission line and the at least one tuning screw is configured to turn inward through a metal bracket toward the microstrip of the microstrip transmission line.

6. The phase-tunable transmission line of claim 5, wherein the metal bracket is connected to a ground plane of the microstrip transmission line through vias.

7. The phase-tunable transmission line of claim 1, wherein the tunable transmission line is a coplanar waveguide transmission line.

8. The phase-tunable transmission line of claim 7, wherein the second conductor is a center conductor of the coplanar waveguide transmission line and the at least one tuning screw is configured to turn inward through a metal bracket toward a center conductor of the coplanar waveguide transmission line.

9. The phase-tunable transmission line of claim 8, wherein the metal bracket is connected to planar conducting strips on either side of the center conductor of the coplanar waveguide transmission line.

10. The phase-tunable transmission line of claim 1, wherein the at least one tuning screw includes a dielectric layer at an inserted end of the tuning screw.

11.-15. (canceled)

16. A Single Sub-Array Antenna Filter Unit, SSA-AFU, comprising:
an antenna calibration, AntCal, circuit configured to couple a signal between a sub-array of antenna elements and a calibration port via a tunable transmission line;
a tunable transmission line between the AntCal circuit and the calibration port, the tunable transmission line including at least one tuning screw configured to adjust a capacitance of the tunable transmission line to adjust a phase of signals transported by the tunable transmission line; and
a calibration port configured to receive a signal transported by the tunable transmission line.

17. The SSA-AFU of claim 16, wherein the tunable transmission line is a coaxial transmission line.

18. The SSA-AFU of claim 17, wherein the first conductor is an outer conductor of the coaxial transmission line and the second conductor is a center conductor of the coaxial transmission line.

19. The SSA-AFU of claim 16, wherein the tunable transmission line is a microstrip transmission line.

20. The SSA-AFU of claim 19, wherein the second conductor is a microstrip of the microstrip transmission line and the at least one tuning screw is configured to turn inward through a metal bracket toward the microstrip of the microstrip transmission line.

21. The SSA-AFU of claim 20, wherein the metal bracket is connected to a ground plane of the microstrip transmission line through vias.

22. The SSA-AFU of claim 16, wherein the tunable transmission line is a coplanar waveguide transmission line.

23. The SSA-AFU of claim 22, wherein the second conductor is a center conductor of the coplanar waveguide transmission line and the at least one tuning screw is configured to turn inward through a metal bracket toward a center conductor of the coplanar waveguide transmission line.

24. The SSA-AFU of claim 23, wherein the metal bracket is connected to planar conducting strips on either side of the center conductor of the coplanar waveguide transmission line.

25. The SSA-AFU of claim 16, wherein the at least one tuning screw includes a dielectric layer at an inserted end of the tuning screw.

26.-33. (canceled)
